(19) United States
(12) Patent Application Publication
(10) Pub. No.: US 2026/0322232 A1
(43) Pub. Date: Oct. 15, 2026

(54) ENERGY CONVERSION DEVICE BASED ON ROTATING LINKAGE ASSEMBLY

(71) Applicant: Xianshu Qiu, Chenzhou City (CN)

(72) Inventor: Xianshu Qiu, Chenzhou City (CN)

(21) Appl. No.: 19/369,994

(22) Filed: Oct. 27, 2025

(30) Foreign Application Priority Data
Apr. 14, 2025 (CN) 202510457899.8

(51) Int. Cl. H02K 53/00; H02K 7/02; H02K 7/10; H02K 7/116

(52) U.S. Cl. CPC H02K 53/00; H02K 7/02; H02K 7/1004; H02K 7/116

(57) ABSTRACT

An energy conversion device based on rotating linkage assembly, comprising a housing, a geared motor, a generator and a linkage assembly. The geared motor and the linkage assembly are arranged inside the housing. The linkage assembly rotates around the speed-changing assembly. The speed-changing assembly is connected to the generator. An extension box is arranged on a side of the housing. A support frame is arranged on a bottom of the housing. The generator is fixed on the housing. The invention realizes effective conversion of input power by rotating the power linkage rod and utilizing the linkage rod principle, thereby reducing energy loss. The invention adopts a modular design concept. Each assembly is independent of each other and connected through a standardized interface.

### TECHNICAL FIELD

The invention relates to the technical field of energy conversion devices, and in particular to an energy conversion device based on rotating linkage assembly.

### BACKGROUND ART

In existing energy conversion devices, such as the motor-generator combination system, due to the large friction between the mechanical transmission components, a large amount of energy is lost during the transmission process. There are friction losses and heat losses in mechanical transmission. These losses usually make the actual conversion efficiency of traditional energy conversion devices low, greatly limiting the effective use of energy.

With the diversification of power demand in modern industry and life, energy conversion devices need to be able to automatically adjust operating parameters according to different load requirements. However, most existing devices lack an effective dynamic adjustment mechanism. When the load changes suddenly, the output voltage and power will fluctuate greatly, which will not only affect the normal operation of the equipment, but may also cause damage to the equipment.

Traditional energy conversion device often contains a large number of complex transmission components, which not only increases the manufacturing cost of the equipment, but also greatly increases the difficulty of equipment maintenance. Each maintenance requires professional technicians to spend a lot of time and energy. The complex structure also makes the equipment bulky and heavy, which brings many inconveniences to the installation and transportation of the equipment.

There are also some energy conversion devices that use the connecting rod principle. Although they can use the amplifying effect of the connecting rod to improve the energy conversion effect to a certain extent, due to their imperfect structural design, the movement of the connecting rod is not stable enough, and it is easy to vibrate and deflect, thus affecting the stability and efficiency of energy conversion. Moreover, these devices are often difficult to adapt to different working conditions and load requirements, and lack flexibility and versatility.

Therefore, it is of great practical significance to develop an energy conversion device with simple structure, high energy conversion efficiency, stable operation and good adaptability.

### SUMMARY OF THE INVENTION

The purpose of the invention is to overcome the above problems and provide an energy conversion device based on rotating linkage assembly. To achieve the above purpose, the invention adopts the following technical solutions:
an energy conversion device based on rotating linkage assembly, comprising a device body, wherein the device body comprises a housing, a geared motor, a generator, and a linkage assembly; the geared motor and the linkage assembly are arranged inside the housing; the geared motor is provided with a motor shaft fixed to one end of the linkage assembly, and the other end of the linkage assembly is provided with a speed-changing assembly; the linkage assembly rotates around the speed-changing assembly, and the speed-changing assembly is connected to the generator; a side of the housing is provided with an extension box, and a bottom of the housing is provided with a support frame; the generator is fixed to the support frame; a side of the geared motor is provided with an optical axis assembly, and the geared motor is connected to the extension box via the optical axis assembly.

As an improvement, the linkage assembly comprises a steel linkage rod, and the motor shaft is provided with a first coupling; the steel linkage rod comprises an outer end and a central end; the first coupling is fixed to a top of the outer end, and a bottom of the outer end is provided with a pulley; a bottom surface of the housing is provided with smooth ceramic tiles, and a bottom of the pulley is arranged on the smooth ceramic tiles.

As an improvement, the speed-changing assembly comprises a gearbox, and the gearbox is provided with an input shaft and an output shaft; a top of the input shaft is provided with a second coupling, and a top of the second coupling is provided with a screw rod fixed to a bottom of the central end.

As an improvement, the output shaft is sleeved with a flywheel disc and a first belt pulley; the generator is provided with a rotating shaft, and the rotating shaft is provided with a second belt pulley; a connecting belt is provided between the first belt pulley and the second belt pulley.

As an improvement, the bottom of the geared motor is provided with a fixing plate, and the fixing plate is provided with a through hole; the motor shaft passes through the through hole, and one end of the optical axis assembly is fixed to the fixing plate.

As an improvement, the optical axis assembly comprises a first optical axis and a second optical axis; both ends of the second optical axis are provided with second fixing seats, and the second optical axis is fixed inside the extension box via the second fixing seats; one end of the first optical axis is provided with a first fixing seat, and the other end of the first optical axis is connected to a sliding block; the first fixing seat is fixed to the fixing plate, and the sliding block is slidably arranged on the second optical axis.

As an improvement, the top of the sliding block is provided with a screw rod, a top of the screw rod is provided with a thread, and a nut is provided on the thread; the screw rod is sleeved with a rod-end bearing joint, and a third coupling is provided between the bearing joint and the first optical axis.

As an improvement, the gearbox comprises a top plate and a bottom plate, and a bracket is provided between the top plate and the bottom plate; the top plate is fixed to a bottom of the housing; the top plate is provided with an input hole, and the bottom plate is provided with an output hole; the input shaft passes through the top plate via the input hole, and a bottom of the input shaft is rotatably connected to the bottom plate; the output shaft passes through the bottom plate via the output hole, and a top of the output shaft is rotatably connected to the top plate.

As an improvement, a transmission shaft is provided in a middle of the gearbox; a top of the transmission shaft is rotatably connected to the top plate, and a bottom of the transmission shaft is rotatably connected to the bottom plate; the input shaft is provided with a first gear, the output shaft is provided with a second gear, and the transmission shaft is provided with a third gear and a fourth gear; the first gear meshes with the third gear, and the second gear meshes with the fourth gear; the number of teeth of the first gear is greater than that of the third gear, and the number of teeth of the fourth gear is greater than that of the second gear.

As an improvement, the support frame is provided with an energy storage battery, and the housing is provided with a power switch, a motor speed regulator, a battery indicator, and a power meter; the generator is electrically connected to the energy storage battery and the battery indicator, and the power switch is electrically connected to the motor speed regulator, the power meter, and the geared motor; a top of the housing is provided with a cover, and the cover is provided with a plug electrically connected to the geared motor.

The advantages of the invention are as follows.
1. The invention realizes effective conversion of input power by rotating the power linkage and utilizing the linkage principle. In the transmission link, the pulley cooperates with the smooth ceramic tiles, and the friction coefficient of the smooth ceramic tiles is small, which effectively reduces friction loss and improves the effective utilization of energy.
2. The invention adopts a modular design concept. Each assembly is independent of each other and connected through a standardized interface. Due to the simplified structure, the size and weight of the equipment are reduced, which solves the installation and transportation difficulties caused by the large size and increased weight of traditional equipment, and significantly reduces the maintenance cost, installation and transportation cost of the equipment.
3. The optical axis assembly design of the device of the invention offsets the displacement deviation caused by the rotation of the connecting rod, avoiding vibration and offset caused by abnormal displacement. With the reasonable gear speed-changing structure and the inertial stabilization of the flywheel disc, the stability of the device during operation is ensured. Compared with some unstable motion devices, the invention effectively improves the stability and efficiency of energy conversion.

### BRIEF DESCRIPTION OF THE DRAWINGS

FIG. 1 is a first plan view of the energy conversion device based on rotating linkage assembly in Embodiment 1 according to the invention.

FIG. 2 is a second plan view of the energy conversion device based on rotating linkage assembly in Embodiment 1 according to the invention.

FIG. 3 is a structural diagram of the energy conversion device based on rotating linkage assembly in Embodiment 1 according to the invention.

FIG. 4 is a structural diagram of the sliding block in Embodiment 1 according to the invention.

FIG. 5 is a structural diagram of the fixing plate in Embodiment 1 according to the invention.

FIG. 6 is a plan view of the gearbox in Embodiment 1 according to the invention.

FIG. 7 is a structural diagram of the gearbox bracket in Embodiment 1 according to the invention.

In the figures:
1 refers to the device body; 2 refers to the housing; 3 refers to the extension box; 4 refers to the support frame; 5 refers to the geared motor; 6 refers to the linkage assembly; 7 refers to the speed-changing assembly; 8 refers to the optical axis assembly; 9 refers to the generator;
11 refers to the energy storage battery; 12 refers to the power switch; 13 refers to the motor speed regulator; 14 refers to the battery indicator; 15 refers to the power meter; 16 refers to the cover; 17 refers to the plug;
21 refers to the smooth ceramic tile; 22 refers to the fixing plate; 23 refers to the through hole;
51 refers to the motor shaft; 52 refers to the first coupling;
61 refers to the steel linkage rod; 62 refers to the outer end; 63 refers to the central end; 64 refers to the pulley;
71 refers to the gearbox; 72 refers to the input shaft; 73 refers to the output shaft; 74 refers to the second coupling; 75 refers to the flywheel disc; 76 refers to the first belt pulley;
711 refers to the top plate; 712 refers to the bottom plate; 713 refers to the bracket; 714 refers to the input hole; 715 refers to the output hole; 716 refers to the transmission shaft; 717 refers to the third gear; 718 refers to the fourth gear;
721 refers to the first gear; 731 refers to the second gear;
81 refers to the first optical axis; 82 refers to the second optical axis; 83 refers to the first fixing seat; 84 refers to the second fixing seat; 85 refers to the sliding block; 86 refers to the screw rod; 87 refers to the rod-end bearing joint; 88 refers to the third coupling;
864 refers to the screw; 862 refers to the nut;
91 refers to the second belt pulley; 92 refers to the connecting belt; 93 refers to the rotating shaft.

### SPECIFIC EMBODIMENT OF THE INVENTION

In order to make the objectives, technical solutions, and advantages of the embodiments of the invention clearer, the technical solutions in the embodiments of the invention will be described clearly and completely hereinafter with reference to the drawings in the embodiments of the invention. Obviously, the described embodiments are part of the embodiments of the invention, rather than all of the embodiments. The components of the embodiments of the invention generally described and illustrated in the drawings herein may be arranged and designed in various different configurations.

In the description of the invention, it needs to be understood that the orientation or positional relationship indicated by the terms “center”, “up”, “down”, “left”, “right”, “vertical”, “horizontal”, “inner”, “outer”, etc. are based on the orientation or positional relationship shown in the drawings, which are only for the convenience of describing the invention and simplifying the description, rather than indicating or implying that the device or element referred to must have a specific orientation, be constructed and operated in a specific orientation, and therefore cannot be understood as a limitation of the invention. In addition, the terms “first”, “second”, and “third” are only used for descriptive purposes, and cannot be understood as indicating or implying relative importance or implicitly indicating the number of indicated technical features.

In addition, the terms “horizontal”, “vertical”, “dangling”, etc. do not mean that the component is required to be absolutely horizontal or hanging, but may be slightly inclined. For example, “horizontal” only means that its direction is more horizontal than “vertical”, it does not mean that the structure must be completely horizontal, but can be slightly inclined.

In the description of the invention, “plurality” means at least two.

In the invention, unless otherwise clearly defined and limited, the terms “provided”, “installed”, “connected” and other terms should be interpreted broadly; for example, it can be a fixed connection, it can be a detachable connection, or integrated; it can be a mechanical connection or an electrical connection; it can be a direct connection, or an indirectly connection through an intermediate medium, and it can be an internal communication between two elements or the interaction relationship between two elements. For those of ordinary skill in the art, the specific meaning of the above terms in the invention can be understood according to specific circumstances.

The invention is described in detail and specifically by specific embodiments hereinafter to provide a better understanding of the invention, but the following embodiments do not limit the protection scope of the invention.

### Embodiment 1

The embodiment discloses an energy conversion device based on rotating linkage assembly.

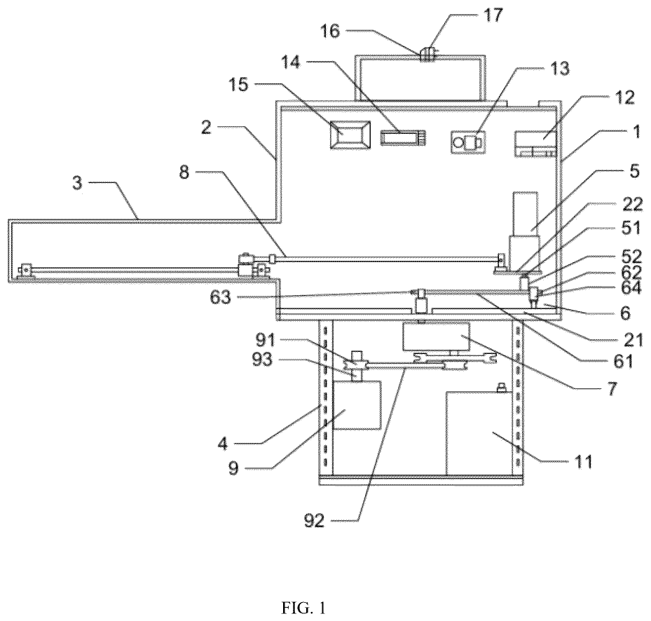

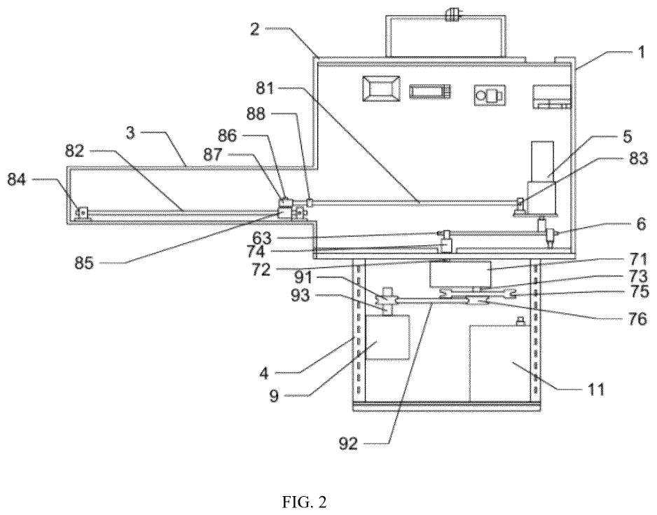

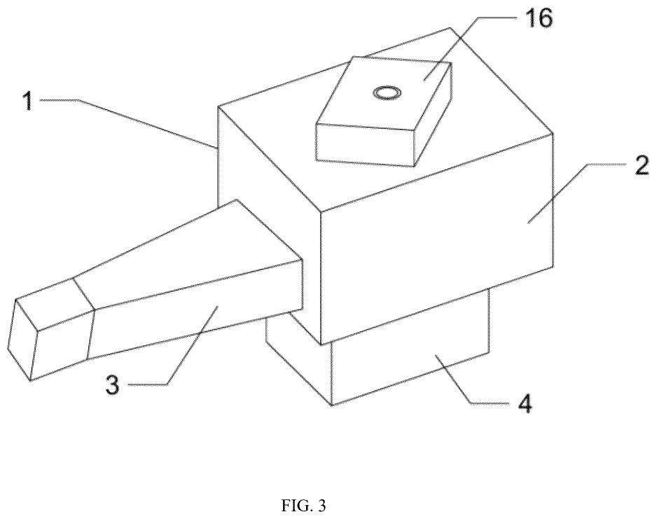

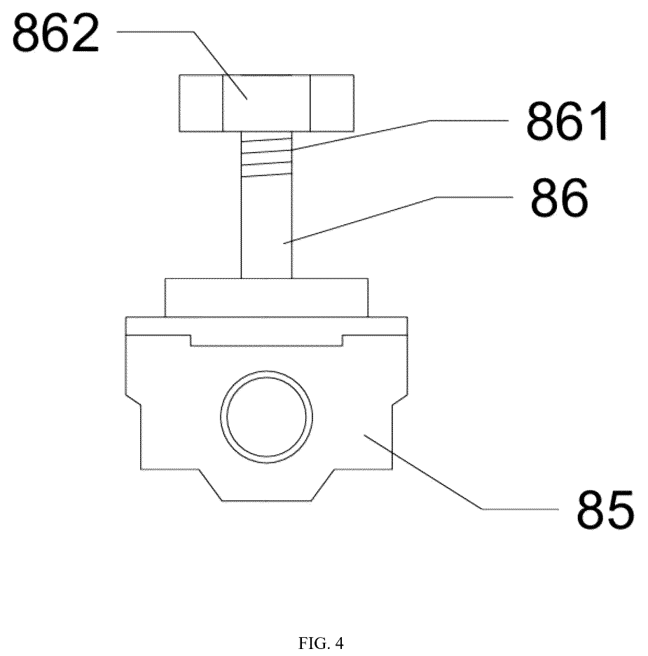

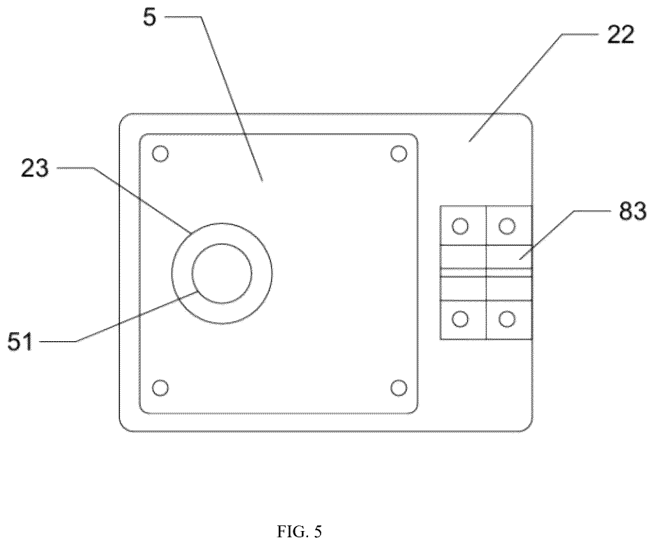

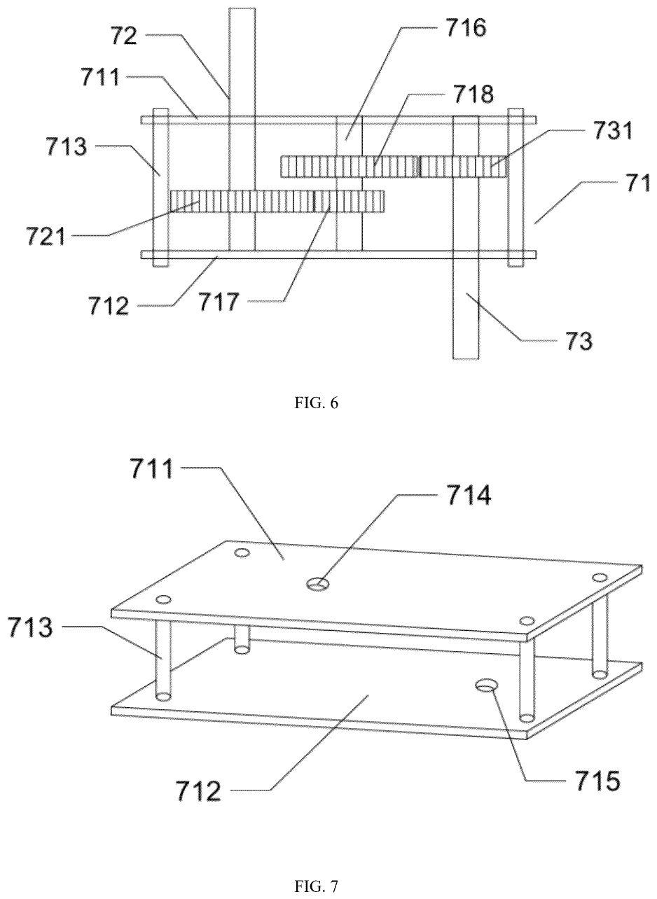

As shown in FIGS. 1-7, the embodiment comprises a device body 1, wherein the device body 1 comprises a housing 2, a geared motor 5, a generator 9, and a linkage assembly 6; the geared motor 5 and the linkage assembly 6 are arranged inside the housing 2; the geared motor 5 is provided with a motor shaft 51 fixed to one end of the linkage assembly 6, and the other end of the linkage assembly 6 is provided with a speed-changing assembly 7; the linkage assembly 6 rotates around the speed-changing assembly 7, and the speed-changing assembly 7 is connected to the generator 9; a side of the housing 2 is provided with an extension box 3, and a bottom of the housing 2 is provided with a support frame 4; the generator 9 is fixed to the support frame 4; a side of the geared motor 5 is provided with an optical axis assembly 8, and the geared motor 5 is connected to the extension box 3 via the optical axis assembly 8.

The housing 2 serves as an outer shell of the entire device, providing protection and installation support for the internal assemblies. The geared motor 5 converts electrical energy into mechanical energy. The motor shaft 51 is connected to one end of the linkage assembly 6, and the output power drives the linkage assembly 6 to operate. The linkage assembly 6 amplifies the power of the motor based on the principle of rotating power linkage rods. The speed-changing assembly 7 connected to the other end can adjust the speed and torque to adapt to the working requirements of the generator 9 and realize the conversion of mechanical energy into electrical energy. The extension box 3 and the support frame 4 are auxiliary structures. The extension box 3 cooperates with the optical axis assembly 8 to allow the geared motor 5 to rotate around the speed-changing assembly 7 during operation to ensure the stable operation of the device; the support frame 4 is used to fix the generator 9.

The linkage assembly 6 comprises a steel linkage rod 61, and the motor shaft 51 is provided with a first coupling 52; the steel linkage rod 61 comprises an outer end 62 and a central end 63; the first coupling 52 is fixed to a top of the outer end 62, and a bottom of the outer end 62 is provided with a pulley 64; a bottom surface of the housing 2 is provided with smooth ceramic tiles 21, and a bottom of the pulley 64 is arranged on the smooth ceramic tiles 21.

The linkage assembly 6 adopts a steel linkage rod 61 made of high-strength alloy steel. This material has high strength and good durability, can withstand large forces, and ensures long-term stable operation of the device. The first coupling 52 is used to connect the motor shaft 51 and the outer end 62 of the steel linkage rod 61 to ensure effective power transmission and reduce losses during power transmission. In order to clarify the connection relationship between the steel linkage rod 61 and other assemblies, the two ends of the steel linkage rod 61 are respectively called the outer end 62 and the central end 63. A pulley 64 is installed at a bottom of the outer end 62 of the steel linkage rod 61, which cooperates with the smooth ceramic tiles 21 on the bottom of the housing 2, greatly reducing the friction when the linkage rod rotates, reducing energy loss, and improving energy conversion efficiency.

The speed-changing assembly 7 comprises a gearbox 71, and the gearbox 71 is provided with an input shaft 72 and an output shaft 73; a top of the input shaft 72 is provided with a second coupling 74, and a top of the second coupling 74 is provided with a screw rod 86 fixed to a bottom of the central end 63.

The input shaft 72 is fixed to a bottom of the central end 63 of the steel linkage 61 through the second coupling 74 and the screw rod 86, thereby achieving a stable connection between the linkage assembly 6 and the speed-changing assembly 7, and transmitting the power of the linkage assembly 6 to the gearbox 71.

The output shaft 73 is sleeved with a flywheel disc 75 and a first belt pulley 76; the generator 9 is provided with a rotating shaft 93, and the rotating shaft 93 is provided with a second belt pulley 91; a connecting belt 92 is provided between the first belt pulley 76 and the second belt pulley 91.

The first pulley 76 on the output shaft 73 is connected to the second pulley 91 on the rotating shaft 93 of the generator 9 through a connecting belt 92, so as to realize the transmission of power from the gearbox 71 to the generator 9. The flywheel disc 75 uses its inertia to respond quickly when the device is started and stopped, and outputs stably during operation, reduces power fluctuations, and ensures the stability of the output power of the generator 9.

The bottom of the geared motor 5 is provided with a fixing plate 22, and the fixing plate 22 is provided with a through hole 23; the motor shaft 51 passes through the through hole 23, and one end of the optical axis assembly 8 is fixed to the fixing plate 22.

The fixing plate 22 provides stable support for the geared motor 5. The through hole 23 on the fixing plate 22 is designed so that the motor shaft 51 can pass through smoothly to achieve connection with the linkage assembly 6 and transmit the power generated by the geared motor 5. The through hole 23 ensures that the motor shaft 51 will not be hindered by the fixing plate 22 during rotation, thereby ensuring the flexibility of the operation of the motor shaft 51.

The optical axis assembly 8 comprises a first optical axis 81 and a second optical axis 82; both ends of the second optical axis 82 are provided with second fixing seats 84, and the second optical axis 82 is fixed inside the extension box 3 via the second fixing seats 84; one end of the first optical axis 81 is provided with a first fixing seat 83, and the other end of the first optical axis 81 is connected to a sliding block 85; the first fixing seat 83 is fixed to the fixing plate 22, and the sliding block 85 is slidably arranged on the second optical axis 82.

The first fixing seat 83 provides a stable installation point for the first optical axis 81, ensuring the reliability of the connection between the first optical axis 81 and the fixing plate 22, so that the first optical axis 81 can follow the movement of the geared motor 5. By connecting with the sliding block 85, the first optical axis 81 can drive the sliding block 85 to slide on the second optical axis 82 to achieve displacement compensation. The two ends of the second optical axis 82 are fixed in the extension box 3 by the second fixing seat 84 to form a stable slide rail. The second fixing seat 84 ensures that the position of the second optical axis 82 is fixed, so that it can provide a stable sliding track for the sliding block 85. On the one hand, the extension box 3 provides an installation space for the second optical axis 82, and on the other hand, through cooperation with the optical axis assembly 8, it realizes auxiliary support and adjustment of the movement of the geared motor 5.

When the reduction geared 5 is working, the geared motor 5 rotates together with the linkage assembly 6. The sliding block 85 slides on the second optical axis 82, and the first optical axis 81 follows the movement of the geared motor 5 and makes corresponding adjustments. This design allows the geared motor 5 to move flexibly, compensates for the displacement deviation caused by the rotation of the linkage rod, ensures the connection stability between the geared motor 5 and other components, reduces equipment vibration and damage caused by abnormal displacement, and improves the stability and reliability of the operation of the entire device.

The top of the sliding block 85 is provided with a screw rod 86, a top of the screw rod 86 is provided with a thread 861, and a nut 862 is provided on the thread 861; the screw rod 86 is sleeved with a rod-end bearing joint 87, and a third coupling 88 is provided between the bearing joint and the first optical axis 81.

The screw rod 86, nut 862, rod-end bearing joint 87 and third coupling 88 at the top of the sliding block 85 cooperate with each other, so that the optical axis assembly 8 can allow the geared motor 5 to perform angle compensation, and can offset the displacement deviation caused by the rotation of the linkage rod in real time, thereby ensuring the normal operation of the geared motor 5 and the linkage assembly 6 and improving the stability of the device operation.

The gearbox 71 comprises a top plate 711 and a bottom plate 712, and a bracket 713 is provided between the top plate 711 and the bottom plate 712; the top plate 711 is fixed to a bottom of the housing 2; the top plate 711 is provided with an input hole 714, and the bottom plate 712 is provided with an output hole 715; the input shaft 72 passes through the top plate 711 via the input hole 714, and a bottom of the input shaft 72 is rotatably connected to the bottom plate 712; the output shaft 73 passes through the bottom plate 712 via the output hole 715, and a top of the output shaft 73 is rotatably connected to the top plate 711.

A transmission shaft 716 is provided in a middle of the gearbox 71; a top of the transmission shaft 716 is rotatably connected to the top plate 711, and a bottom of the transmission shaft 716 is rotatably connected to the bottom plate 712; the input shaft 72 is provided with a first gear 721, the output shaft 73 is provided with a second gear 731, and the transmission shaft 716 is provided with a third gear 717 and a fourth gear 718; the first gear 721 meshes with the third gear 717, and the second gear 731 meshes with the fourth gear 718; the number of teeth of the first gear 721 is greater than that of the third gear 717, and the number of teeth of the fourth gear 718 is greater than that of the second gear 731.

A transmission shaft 716 is provided in the gearbox 71, and the gears are meshed with each other to achieve speed change. The number of teeth of the first gear 721 is greater than that of teeth of the third gear 717, and the two mesh to achieve the first speed increase; the number of teeth of the fourth gear 718 is greater than that of teeth of the second gear 731, and the fourth gear 718 meshes again to achieve speed increase. This design optimizes the speed and torque of the output shaft 73, meets the working requirements of the generator 9, and improves the energy conversion efficiency of the device.

The support frame 4 is provided with an energy storage battery 11, and the housing 2 is provided with a power switch 12, a motor speed regulator 13, a battery indicator 14, and a power meter 15; the generator 9 is electrically connected to the energy storage battery 11 and the battery indicator 14, and the power switch 12 is electrically connected to the motor speed regulator 13, the power meter 15, and the geared motor 5; a top of the housing 2 is provided with a cover 16, and the cover 16 is provided with a plug 17 electrically connected to the geared motor 5.

The energy storage battery 11 is used to store the electric energy generated by the generator 9. The lead-acid battery has a moderate capacity and meets the common power demand. Its balanced charging function can extend the battery life. The power switch 12 controls the start and stop of the device, the motor speed regulator 13 adjusts the speed of the geared motor 5, the battery indicator 14 displays the battery power in real time, and the power meter 15 displays the output power of the device.

The generator 9 is electrically connected to the energy storage battery 11 and the battery indicator 14 to realize the storage of the generated energy and the real-time display of the power; the power switch 12 is electrically connected to the motor speed regulator 13, the power meter 15, and the geared motor 5 to facilitate the control of the operating state of the device. The plug 17 on the cover 16 is convenient for connecting to an external power supply to power the geared motor 5.

The overall operation process of the device is as follows.
1. Initial preparation and power on: connect the power supply through the plug 17 on the cover 16, close the power switch 12 in the housing 2, and supply power the entire device. At this time, the motor speed regulator 13, power meter 15, etc. are in an operational state, and the operating parameters of the device can be monitored and preliminarily adjusted.
2. Start the geared motor 5 and move the linkage assembly. After the geared motor 5 is powered on, it starts to run, and the motor shaft 51 rotates accordingly. The motor shaft 51 is connected to a top of the outer end 62 of the steel linkage rod 61 through the first coupling 52, driving the steel linkage rod 61 to rotate around the speed-changing assembly 7. The pulley 64 at a bottom of the outer end 62 of the steel linkage rod 61 rolls on the smooth ceramic tiles 21 on a bottom surface of the housing 2, reducing the friction when the linkage rod rotates, so that the linkage rod rotates more smoothly.
3. The speed transmission of the speed-changing assembly 7: a bottom of the central end 63 of the steel linkage rod 61 is connected to the second coupling 74 at a top of the input shaft 72 of the gearbox 71 through the screw rod 86. When the steel linkage rod 61 rotates, it drives the input shaft 72 to rotate. The first gear 721 on the input shaft 72 is meshed with the third gear 717 on the transmission shaft 716. Since the number of teeth of the first gear 721 is greater than that of the third gear 717, according to the gear transmission principle, a first-stage speed increase is achieved. The fourth gear 718 on the transmission shaft 716 is meshed with the second gear 731 on the output shaft 73, and the number of teeth of the fourth gear 718 is greater than that of the second gear 731, further achieving speed increase. After two-stage gear transmission, the speed increase is achieved on the output shaft 73. The flywheel disc 75 sleeved on the output shaft 73 can store the moment of inertia, so that the output shaft 73 rotates more smoothly.
4. The generator 9 generates electricity, and the first pulley 76 on the output shaft 73 is connected to the second pulley 91 on the rotating shaft 93 of the generator 9 through the connecting belt 92. When the output shaft 73 rotates, the rotating shaft 93 of the generator 9 is driven to rotate through the connecting belt 92, and the coil inside the generator 9 cuts the magnetic flux lines in the magnetic field to generate an induced electromotive force, thereby realizing power generation.
5. Auxiliary role of the optical axis assembly 8: for the optical axis assembly 8 on the fixing plate 22 at the bottom of the geared motor 5, wherein one end of the first optical axis 81 is fixed to the fixing plate 22 through the first fixing seat 83, and the sliding block 85 at the other end is slidably arranged on the second optical axis 82. When the geared motor 5 is working, the movement of the linkage assembly may cause the geared motor 5 to produce a certain displacement and angle change, the sliding block 85 can slide on the second optical axis 82, and the first optical axis 81 follows the adjustment to compensate for the displacement deviation caused by the rotation of the linkage rod, so as to ensure the stable connection between the geared motor 5 and other components and reduce the vibration and damage of the equipment.
6. Electric energy storage and monitoring: the electric energy generated by the generator 9 is transmitted to the energy storage battery 11 for storage, and the battery indicator 14 displays the battery power and other status information in real time. The power meter 15 can monitor the power and other parameters of the device in real time during operation, and the motor speed regulator 13 can adjust the speed of the geared motor 5 according to actual needs to optimize the energy conversion efficiency of the device.

The specific embodiments of the invention have been described in detail hereinabove, but they are only examples, and the invention is not equivalent to the specific embodiments described hereinabove. For those skilled in the art, any equivalent modifications and substitutions made to the invention shall all fall within the scope of the invention. Therefore, the equalization changes and modifications made without departing from the spirit and scope of the invention should be included in the scope of the invention.

1. An energy conversion device based on rotating linkage assembly, comprising a device body, wherein the device body comprises a housing, a geared motor, a generator, and a linkage assembly; the geared motor and the linkage assembly are arranged inside the housing; the geared motor is provided with a motor shaft fixed to one end of the linkage assembly, and the other end of the linkage assembly is provided with a speed-changing assembly; the linkage assembly rotates around the speed-changing assembly, and the speed-changing assembly is connected to the generator; a side of the housing is provided with an extension box, and a bottom of the housing is provided with a support frame; the generator is fixed to the support frame; a side of the geared motor is provided with an optical axis assembly, and the geared motor is connected to the extension box via the optical axis assembly.

2. The energy conversion device based on rotating linkage assembly of claim 1, wherein the linkage assembly comprises a steel linkage rod, and the motor shaft is provided with a first coupling; the steel linkage rod comprises an outer end and a central end; the first coupling is fixed to a top of the outer end, and a bottom of the outer end is provided with a pulley; a bottom surface of the housing is provided with smooth ceramic tiles, and a bottom of the pulley is arranged on the smooth ceramic tiles.

3. The energy conversion device based on rotating linkage assembly of claim 2, wherein the speed-changing assembly comprises a gearbox, and the gearbox is provided with an input shaft and an output shaft; a top of the input shaft is provided with a second coupling, and a top of the second coupling is provided with a screw rod fixed to a bottom of the central end.

4. The energy conversion device based on rotating linkage assembly of claim 3, wherein the output shaft is sleeved with a flywheel disc and a first belt pulley; the generator is provided with a rotating shaft, and the rotating shaft is provided with a second belt pulley; a connecting belt is provided between the first belt pulley and the second belt pulley.

5. The energy conversion device based on rotating linkage assembly of claim 4, wherein the bottom of the geared motor is provided with a fixing plate, and the fixing plate is provided with a through hole; the motor shaft passes through the through hole, and one end of the optical axis assembly is fixed to the fixing plate.

6. The energy conversion device based on rotating linkage assembly of claim 5, wherein the optical axis assembly comprises a first optical axis and a second optical axis; both ends of the second optical axis are provided with second fixing seats, and the second optical axis is fixed inside the extension box via the second fixing seats; one end of the first optical axis is provided with a first fixing seat, and the other end of the first optical axis is connected to a sliding block; the first fixing seat is fixed to the fixing plate, and the sliding block is slidably arranged on the second optical axis.

7. The energy conversion device based on rotating linkage assembly of claim 6, wherein the top of the sliding block is provided with a screw rod, a top of the screw rod is provided with a thread, and a nut is provided on the thread; the screw rod is sleeved with a rod-end bearing joint, and a third coupling is provided between the bearing joint and the first optical axis.

8. The energy conversion device based on rotating linkage assembly of claim 7, wherein the gearbox comprises a top plate and a bottom plate, and a bracket is provided between the top plate and the bottom plate; the top plate is fixed to a bottom of the housing; the top plate is provided with an input hole, and the bottom plate is provided with an output hole; the input shaft passes through the top plate via the input hole, and a bottom of the input shaft is rotatably connected to the bottom plate; the output shaft passes through the bottom plate via the output hole, and a top of the output shaft is rotatably connected to the top plate.

9. The energy conversion device based on rotating linkage assembly of claim 8, wherein a transmission shaft is provided in a middle of the gearbox; a top of the transmission shaft is rotatably connected to the top plate, and a bottom of the transmission shaft is rotatably connected to the bottom plate; the input shaft is provided with a first gear, the output shaft is provided with a second gear, and the transmission shaft is provided with a third gear and a fourth gear; the first gear meshes with the third gear, and the second gear meshes with the fourth gear; the number of teeth of the first gear is greater than that of the third gear, and the number of teeth of the fourth gear is greater than that of the second gear.

10. The energy conversion device based on rotating linkage assembly of claim 9, wherein the support frame is provided with an energy storage battery, and the housing is provided with a power switch, a motor speed regulator, a battery indicator, and a power meter; the generator is electrically connected to the energy storage battery and the battery indicator, and the power switch is electrically connected to the motor speed regulator, the power meter, and the geared motor; a top of the housing is provided with a cover, and the cover is provided with a plug electrically connected to the geared motor.
